(19) United States
(12) Patent Application Publication
(10) Pub. No.: US 2007/0018994 A1
(43) Pub. Date: Jan. 25, 2007

(54) Texture encoding apparatus, texture decoding apparatus, method, and program

(75) Inventor: Masahiro Sekine, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/490,149

(22) Filed: Jul. 21, 2006

(30) Foreign Application Priority Data
Jul. 20, 2005 (JP) 2005-210318

(51) Int. Cl. G09G 5/00

(52) U.S. Cl. 345/582

(57) ABSTRACT

A texture encoding apparatus includes a texture data acquisition unit configured to acquire texture data of a texture set provided under a plurality of different conditions, a block segmentation unit configured to segment the texture data into a plurality of block data items each of which contains a plurality of pixel data items whose values corresponding to the conditions fall within a first range and whose pixel positions fall within a second range in the texture set, a block data encoding unit configured to encode each of the block data items to produce a plurality of encoded block data items, and a block data concatenation unit configured to concatenate the encoded block data items to generate an encoded data item of the texture set.

### CROSS REFERENCE TO RELATED APPLICATIONS

This is a Continuation Application of PCT Application No. PCT/JP2006/306772, filed Mar. 24, 2006, which was published under PCT Article 21(2) in English.

This application is based upon and claims the benefit of priority from prior Japanese Patent Application No. 2005-210318, filed Jul. 20, 2005, the entire contents of which are incorporated herein by reference.

### BACKGROUND OF THE INVENTION

1. Field of the Invention

The present invention relates to a texture encoding apparatus, texture decoding apparatus, method, and program having a high-quality texture mapping technique in the three-dimensional (3D) computer graphics field and, more particularly, to a texture encoding apparatus, texture decoding apparatus, method, and program, which compress a data amount by encoding texture data acquired or created under a plurality of conditions or efficiently decode and map texture data in texture mapping on a graphics LSI.

2. Description of the Related Art

In recent years, 3D computer graphics (CG) technology has made rapid advances, enabling very realistic graphics rendering that look like actually photographed scenes. However, most high-quality CGs for movies or TV are produced manually by their creators' long laborious work at enormous cost. Since more diverse CG rendering is likely to be requested in the future, the challenge is to easily create high-quality CG at a low cost.

In CG rendering, it is especially difficult to render cloth, skin, or hair. In such materials having a soft feel, it is very important to express the color of an object or the self shadow of an object, which changes depending on the direction to see the object (viewpoint direction) and the direction of lighting (light source direction). In a method often used recently, a material which exists actually is photographed, and its characteristic is reproduced to create realistic CG. For rendering of a surface feel corresponding to the viewpoint direction or light source direction, modeling methods called a bi-directional reference distribution function (BRDF), a bi-directional texture function (BTF), and polynomial texture maps (PTM) are being researched and developed (e.g., U.S. Pat. No. 6,297,834).

When the optical characteristics of an object surface which change in accordance with the viewpoint direction or light source direction are to be rendered by using texture data, voluminous texture images under different conditions of the viewpoint direction or light source direction are necessary. Hence, no practical system is available presently.

These methods employ an approach to derive a function model by analyzing acquired data. There is however a limit in converting irregular changes in shadow or luminance of an actually existing material, and many problems remain unsolved. One of the biggest problems is the enormous amount of data.

### BRIEF SUMMARY OF THE INVENTION

In accordance with a first aspect of the invention, there is provided a texture encoding apparatus comprising: a texture data acquisition unit configured to acquire texture data of a texture set provided under a plurality of different conditions; a block segmentation unit configured to segment the texture data into a plurality of block data items each of which contains a plurality of pixel data items whose values corresponding to the conditions fall within a first range and whose pixel positions fall within a second range in the texture set; a block data encoding unit configured to encode each of the block data items to produce a plurality of encoded block data items; and a block data concatenation unit configured to concatenate the encoded block data items to generate an encoded data item of the texture set.

In accordance with a second aspect of the invention, there is provided a texture encoding apparatus comprising: a texture data acquisition unit configured to acquire texture data of a texture set provided under a plurality of different conditions; a block segmentation unit configured to segment the texture data into a plurality of block data items each of which contains a plurality of pixel data items whose values corresponding to the conditions fall within a first range and whose pixel positions fall within a second range in the texture set; a block data encoding unit configured to encode each of the block data items to produce a plurality of encoded block data items; an error calculation unit configured to calculate an encoding error of each of the encoded block data items; a comparison unit configured to compare, for each of the encoded block data items, the calculated encoding error with an allowance condition indicating an encoding error within a range; and a block data concatenation unit configured to concatenate the encoded block data items whose calculated encoding errors satisfy the allowance condition, wherein each of the block data items whose calculated encoding error fails to satisfy the allowance condition is segmented into a block data item having a smaller data amount than the segmented block data by the block segmentation unit.

In accordance with a third aspect of the invention, there is provided a texture decoding apparatus comprising: an encoded data acquisition unit configured to acquire encoded data of a texture set provided under a plurality of different conditions; a designated data acquisition unit configured to acquire a plurality of texture coordinates for designating pixel positions and a conditional parameter for designating a condition in the conditions; a block data load unit configured to load, from the encoded data, a block data item corresponding to the texture coordinates and the conditional parameter; a block data decoding unit configured to decode the loaded block data item; and a pixel data calculation unit configured to calculate a plurality of pixel data items based on the decoded data item.

In accordance with a fourth aspect of the invention, there is provided a texture decoding apparatus comprising: an encoded data acquisition unit configured to acquire encoded data of a texture set provided under a plurality of different conditions; an encoded data conversion unit configured to convert a size of a block contained in the encoded data into a fixed block size; a designated data acquisition unit configured to acquire a plurality of texture coordinates for designating pixel positions and a conditional parameter for designating a condition in the conditions; a block data load unit configured to load, from the converted encoded data, a block data item corresponding to the texture coordinates and the conditional parameter; a block data decoding unit configured to decode the loaded block data item; and a pixel data calculation unit configured to calculate a plurality of pixel data items based on the decoded block data item.

### BRIEF DESCRIPTION OF THE SEVERAL VIEWS OF THE DRAWING

FIG. 1 is a block diagram of a texture encoding apparatus according to the first embodiment of the present invention;

FIG. 2 is a flowchart showing the operation of the texture encoding apparatus according to the first embodiment of the present invention;

FIG. 3 is a view showing angle parameters which indicate a viewpoint and a light source position when an input unit shown in FIG. 1 acquires texture;

FIG. 4 is a view showing the distributions of pixel data and representative vectors;

FIG. 5 is a view showing the encoding format of a block data encoded by an encoding method corresponding to FIG. 4;

FIG. 6 is a view showing a block data encoding using vector differences;

FIG. 7 is a view showing the encoding format of a block data encoded by an encoding method corresponding to FIG. 6;

FIG. 8 is a view showing a block data encoding using an interpolation ratio;

FIG. 9 is a view showing the encoding format of a block data encoded by an encoding method corresponding to FIG. 8;

FIG. 10 is a view showing a block data encoding using an index which only instructs interpolation;

FIG. 11 is a view showing the encoding format of a block data encoded by an encoding method corresponding to FIG. 10;

FIG. 12 is a view showing the encoding format of a block data using a macro block or a code book of the entire texture;

FIG. 13 is a view showing the encoding format of a block data segmented for each vector component;

FIG. 14 is a view showing the encoded data structure of a texture set;

FIG. 15 is a view showing the outline of processing of the texture encoding apparatus shown in FIG. 1;

FIG. 16 is a view showing the outline of conventional processing corresponding to FIG. 15;

FIG. 17 is a flowchart showing a calculation method of a representative vector which is calculated in step S203 in FIG. 2;

FIG. 18 is a flowchart showing a block segmentation method by a texture encoding apparatus according to the second embodiment of the present invention;

FIG. 19 is a block diagram of the texture encoding apparatus which segments a block by using an encoding error in the second embodiment of the present invention;

FIG. 20 is a view showing an encoded data structure containing block addressing data to be used in the texture encoding apparatus shown in FIG. 19;

FIG. 21 is a block diagram of a texture decoding apparatus according to the third embodiment of the present invention;

FIG. 22 is a flowchart showing the operation of the texture decoding apparatus shown in FIG. 21;

FIGS. 23A and 23B are views showing a texture data layout method based on u and v directions;

FIGS. 24A and 24B are views showing a texture data layout method based on a θ direction;

FIGS. 25A and 25B are views showing a texture data layout method based on a φ direction;

FIGS. 26A and 26B are views showing a method which slightly changes the texture data layout in FIGS. 24A and 25A;

FIG. 27 is a block diagram of a texture decoding apparatus according to the fourth embodiment of the present invention; and

FIG. 28 is a view showing conversion from a flexible block size to a fixed block size.

### DETAILED DESCRIPTION OF THE INVENTION

A texture encoding apparatus, texture decoding apparatus, method, and program according to the embodiments of the present invention will be described below in detail with reference to the accompanying drawing.

According to the texture encoding apparatus, method, and program of the embodiments, the data amount can be compressed. According to the texture decoding apparatus, method, and program, the processing speed of loading required pixel data can also be increased.

The texture encoding apparatus, texture decoding apparatus, method, and program according to the embodiments of the present invention are an apparatus, method, and program to encode or decode a texture set acquired or created under a plurality of conditions including different viewpoints and light sources and execute texture mapping processing for graphics data.

The texture encoding apparatus, texture decoding apparatus, method, and program according to the embodiments of the present invention can efficiently implement texture rendering of a material surface which changes in accordance with the viewpoint direction or light source direction and can also be applied to various conditions or various components.

Application to various conditions indicates that the embodiment of the present invention can also be applied to a signal which changes depending on not only the viewpoint condition or light source condition but also various conditions such as the time, speed, acceleration, pressure, temperature, and humidity in the natural world.

Application to various components indicates that the embodiment of the present invention can be applied not only to a color component as a pixel data but also to, e.g., a normal vector component, depth component, transparency component, or illumination effect component.

(First Embodiment)

In the first embodiment, an example of a series of processing operations of a texture encoding apparatus will be described. A block segmentation unit of this embodiment executes segmentation in a fixed block size. Processing of causing various a block data encoding means to encode a block data segmented in a fixed size will be described in detail.

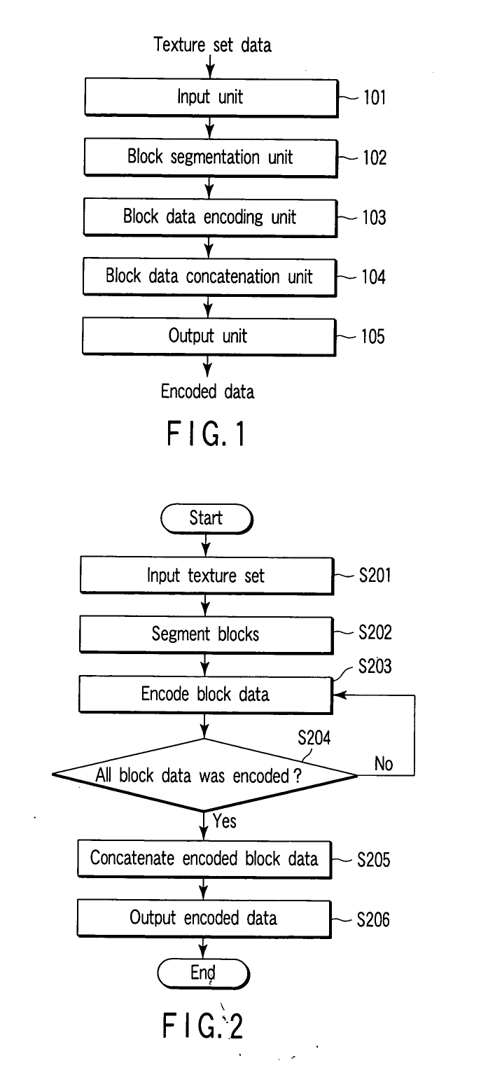

The arrangement of the texture encoding apparatus according to this embodiment will be described with reference to FIG. 1.

The texture encoding apparatus shown in FIG. 1 receives a texture set acquired or created under a plurality of different conditions, segments the data into blocks in the pixel position direction and condition change direction (e.g., the light source direction and viewpoint direction), and encodes each block.

The texture encoding apparatus of this embodiment comprises an input unit 101, block segmentation unit 102, block data encoding unit 103, block data concatenation unit 104, and output unit 105.

The input unit 101 inputs data of a texture set acquired or created under a plurality of different conditions.

The block segmentation unit 102 segments the data of the texture set into a plurality of block data by forming a block which contains a plurality of pixel data having close acquisition conditions and close pixel positions in the texture set input by the input unit 101.

The block data encoding unit 103 encodes each block data segmented by the block segmentation unit 102.

The block data concatenation unit 104 concatenates the block data encoded by the block data encoding unit 103 to generate encoded data of the texture set.

The output unit 105 outputs the encoded data of the texture set generated by the block data concatenation unit 104.

The operation of the texture encoding apparatus according to this embodiment will be described with reference to FIG. 2.

<Step S201>

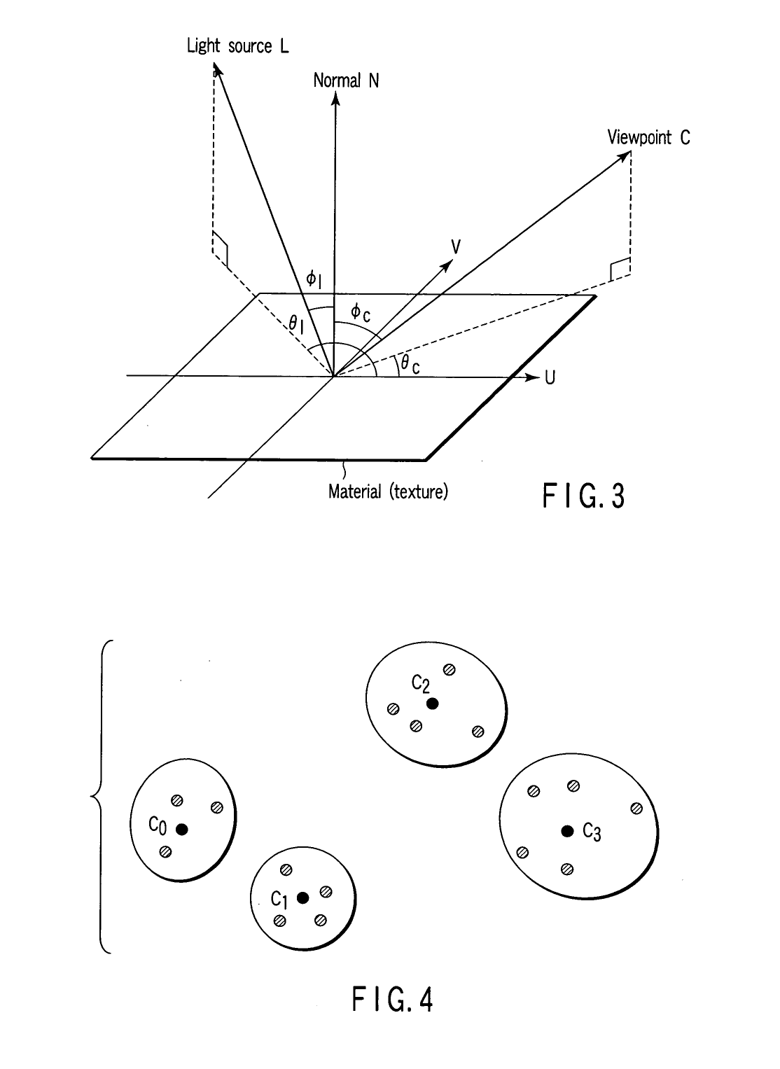

The input unit 101 inputs data of a texture set. In a space shown in FIG. 3, textures are acquired while changing the viewpoint and light source position (i.e., θc, φc, θl, and φl shown in FIG. 3) at a predetermined interval.

The input unit 101 acquires textures while changing the angles as shown in Table 1. The units are degrees. In this case, 18 texture samples are acquired in the θ direction by changing the viewpoint and light source at an interval of 20° while 8 texture samples are acquired in the φ direction by changing the viewpoint and light source up to 70° at an interval of 10°. Hence, a total of 20,736 (18×8×18×8) textures are acquired. If the texture size is 256×256 pixels (24 bit colors), the data amount is about 3.8 GB and cannot be handled practically as a texture material to be used for texture mapping.

TABLE 1

| | | | | | | | | | |
|---|---|---|---|---|---|---|---|---|---|
| Θ_{c} | 0 | 20 | 40 | 60 | 80 | 100 | 120 | 140 | 160 |
| | 180 | 200 | 220 | 240 | 260 | 280 | 300 | 320 | 340 |
| Φ_{c} | 0 | 10 | 20 | 30 | 40 | 50 | 60 | 70 | |
| Θₗ | 0 | 20 | 40 | 60 | 80 | 100 | 120 | 140 | 160 |
| | 180 | 200 | 220 | 240 | 260 | 280 | 300 | 320 | 340 |
| Φₗ | 0 | 10 | 20 | 30 | 40 | 50 | 60 | 70 | |

A method of expressing a texture of an arbitrary size by small texture data by using, e.g., a higher-order texture generation technique can be used. In this higher-order texture generation technique, using a texture set acquired or created under a plurality of different conditions, a texture of an arbitrary size is reproduced only by generating a texture set of an arbitrary size corresponding to each condition and holding the data of the small texture set. If the texture size can be 32×32 pixels, the data amount is about 60 MB. However, the texture data is not compressed yet sufficiently and must be further compressed.

<Step S202>

Next, the block segmentation unit 102 segments the acquired texture set into blocks. In this block segmentation processing, pixel data having close parameter numerical values are regarded as one set and put into a block. A parameter here indicates a variable representing a position or condition to load the pixel data, including u representing the horizontal texture coordinate, v representing the vertical texture coordinate, θc or φc representing the condition of the viewpoint direction, and θl or φl representing the condition of the light source direction. In this embodiment, the pixel data can be loaded by using six-dimensional parameters: (u, v, θc, φc, θl, φl).

The number of the pixel data to be contained in one block can be freely determined. In this embodiment, data is segmented into blocks having a fixed size. For example, assume that pixel data are sampled at the same pixel position twice at each of four dimensions θc, φc, θl, and φl, and the acquired pixel data is put in one block. In this case, one block data has a structure shown in Table 2.

TABLE 2

| | | | | | | | | | | | | | | | | |
|---|---|---|---|---|---|---|---|---|---|---|---|---|---|---|---|---|
| u | 0 | 0 | 0 | 0 | 0 | 0 | 0 | 0 | 0 | 0 | 0 | 0 | 0 | 0 | 0 | 0 |
| V | 0 | 0 | 0 | 0 | 0 | 0 | 0 | 0 | 0 | 0 | 0 | 0 | 0 | 0 | 0 | 0 |
| θ_{c} | 0 | 0 | 0 | 0 | 0 | 0 | 0 | 0 | 20 | 20 | 20 | 20 | 20 | 20 | 20 | 20 |
| φ_{c} | 0 | 0 | 0 | 0 | 10 | 10 | 10 | 10 | 0 | 0 | 0 | 0 | 10 | 10 | 10 | 10 |
| θₗ | 0 | 0 | 20 | 20 | 0 | 0 | 20 | 20 | 0 | 0 | 20 | 20 | 0 | 0 | 20 | 20 |
| φₗ | 0 | 10 | 0 | 10 | 0 | 10 | 0 | 10 | 0 | 10 | 0 | 10 | 0 | 10 | 0 | 10 |

Table 2 shows that 16 pixel data is put into one block, including pixel data loaded under a condition (u, v, θc, φc, θl, φl)=(0, 0, 0, 0, 0, 0) and pixel data which satisfies the combinations of the respective columns. When the block segmentation unit 102 executes such block formation, for example, 20,736 textures each having a size of 32×32 pixels, i.e., 21,233,664 (=20,736×32×32) pixel data is segmented into 1,327,104 (=21,233,664÷16) block data.

The block segmentation unit 102 can also execute block segmentation in the dimensions u and v, i.e., in the texture space direction. In this embodiment, however, only pixel data at the same pixel position is contained in a block. This is because encoding at the same pixel position is suitable for the above-described higher-order texture generation technique. With this segmentation method, the feature of each pixel can be checked approximately in the encoded data so that the similarity between pixels can easily be checked. Hence, after encoding the texture set, mapping to graphics data may be done after a texture of an arbitrary size is generated.

<Steps S203 and S204>

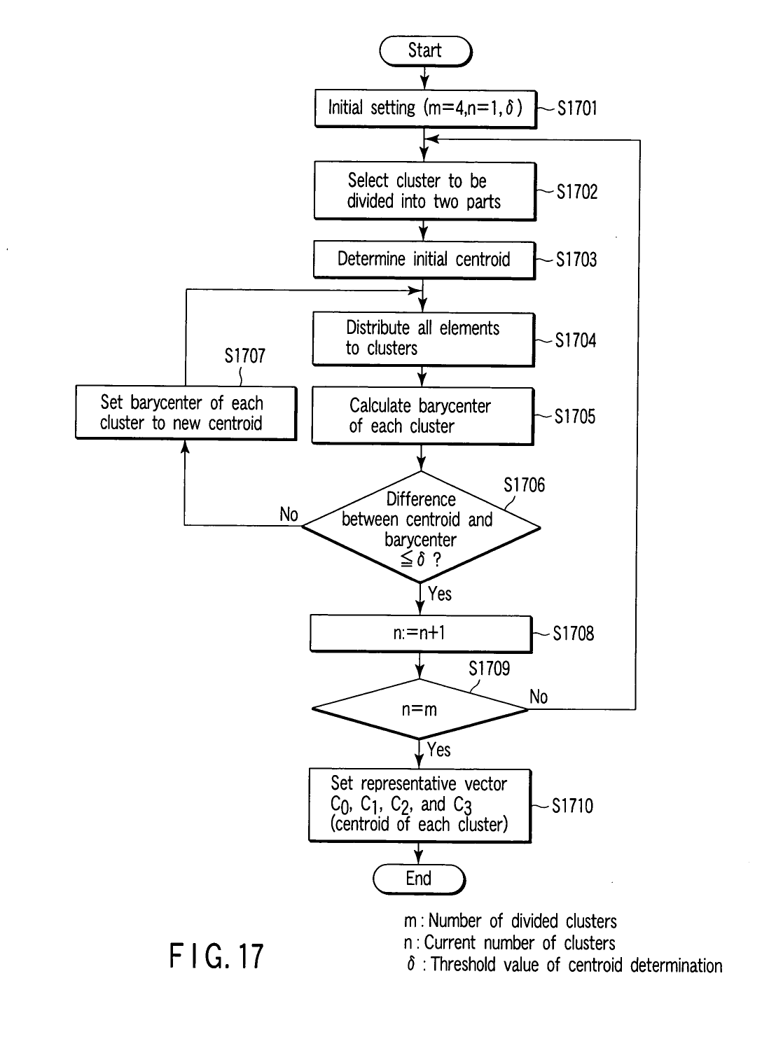

Next, the block data encoding unit 103 encodes each block data. Step S203 is performed until all block data is encoded (step S204). In the block data encoding processing, for example, four representative vectors are calculated from 16 pixel data (color vector data ) by using vector quantization. The representative vector calculation method will be described later with reference to FIG. 17. As the calculation method, the well-known vector quantization called K-means or LBG is used.

If 16 pixel data (hatched circles) has a distribution shown in FIG. 4, representative vectors indicated by filled circles can be obtained by vector quantization. Thus obtained representative vectors <C₀>, <C₁>, <C₂>, and <C₃> are defined as code book data in the block (<A> represents “vector A”; vectors will be expressed according to this notation hereinafter). Index data representing which representative vector is selected by each of the 16 pixel data is expressed by 2 bits.

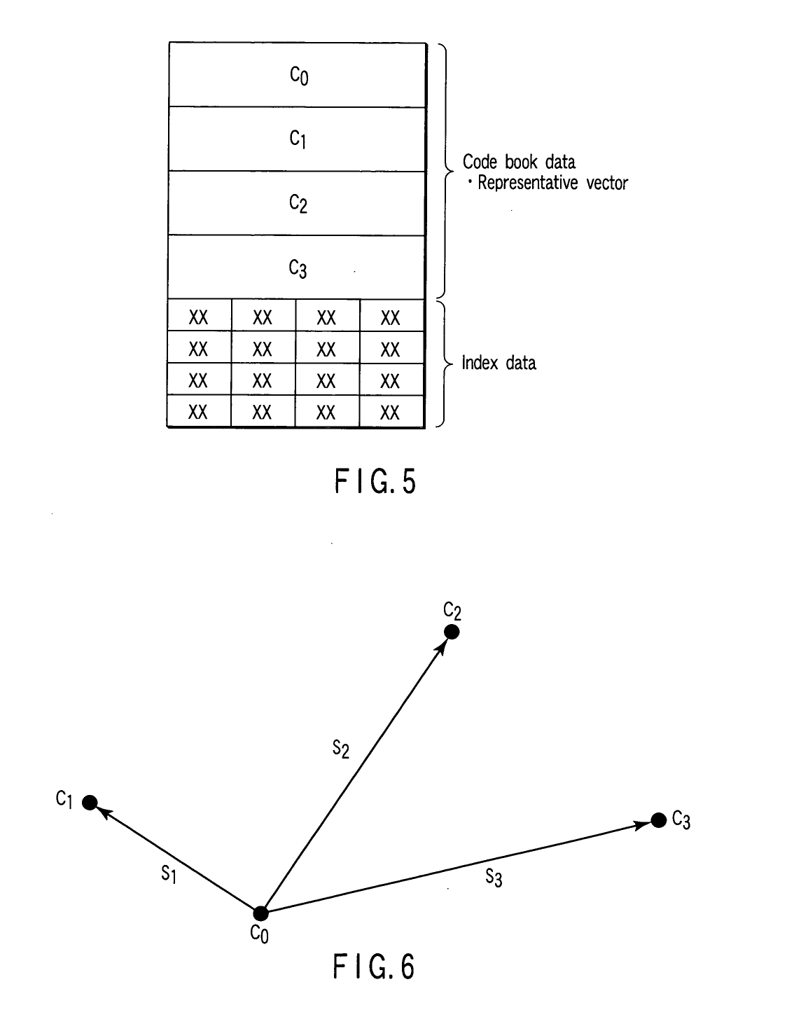

FIG. 5 shows the format of the encoded block data. According to the rule, <C₀> is selected if index data is “00”, <C₁> for “01”, <C₂> for “10”, and <C₃> for “11”. In this way, the representative vector for decoding is selected in accordance with the value of index data. This is the most basic encoding method. Alternatively, encoding methods to be described below can be used. Five examples will be described here.

1. <<Encoding Using Vector Differences>>

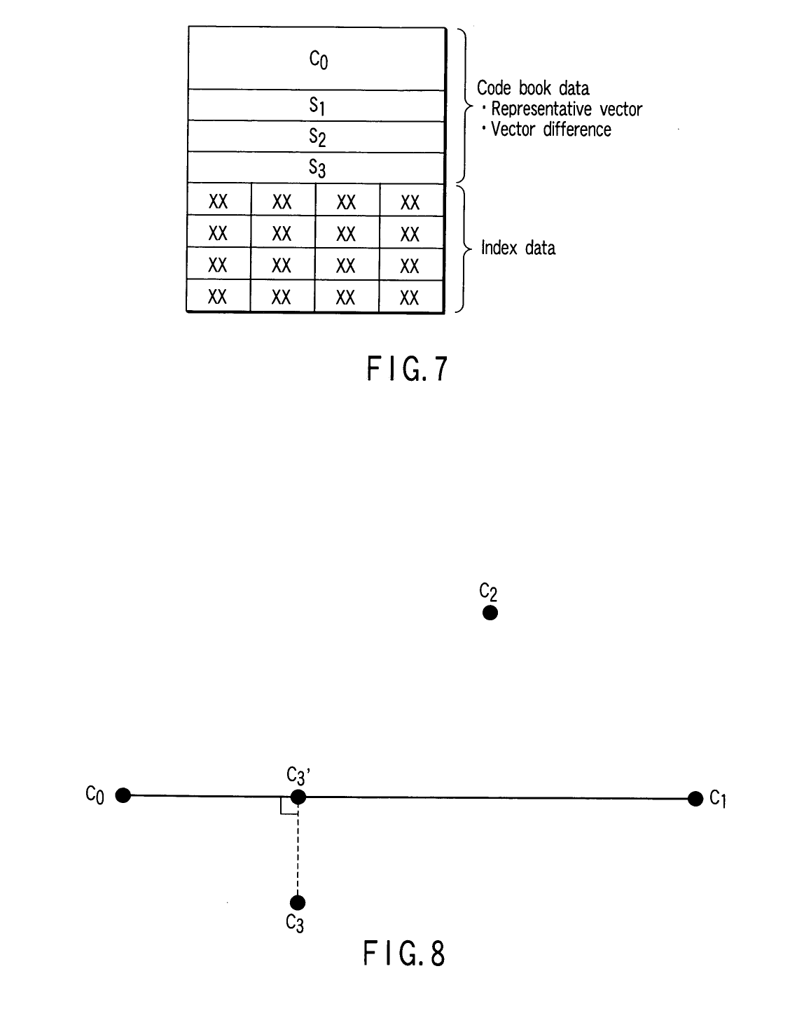

Until obtaining four representative vectors, the processing is executed by the same method as described above. Then, one of the representative vectors is defined as a reference vector. The remaining representative vectors are converted into vectors representing variations from the reference vector. FIG. 6 shows this state. After the representative vectors <C₀>, <C₁>, <C₂>, and <C₃> are obtained, three vector differences <S₁>, <S₂>, and <S₃> given by
<S₁>=<C₁>−<C₀>,
<S₂>=<C₂>−<C₀>,
<S₃>=<C₃>−<C₀>
are obtained. FIG. 7 shows encoded data with a code book containing a thus calculated representative vector and vector differences. The method of encoding data by using vector differences is very effective for a material whose color does not change so much in accordance with a change of the viewpoint direction or light source direction. This is because a vector difference only needs to express a variation, and to do this, assignment of a small number of bits suffices. The balance between the number of representative vectors and the number of vector differences may be changed depending on the color vector distribution. When a reference vector capable of minimizing vector differences is selected from the representative vectors <C₀>, <C₁>, <C₂>, and <C₃>, the number of bits to be assigned to each vector difference can further be decreased.
2. <<Encoding Using Interpolation Ratio>>

Until obtaining four representative vectors, the processing is executed by the same method as described above. Then, calculation is executed to approximately express one representative vector by interpolating two of the remaining representative vectors. FIG. 8 shows a detailed example. In this case, an interpolation ratio is calculated to approximately express <C₃> by using <C₀> and <C₁>. A perpendicular is drawn from the point <C₃> to the line segment <C₀><C₁>, and its foot is defined as a point <C₃>′. An interpolation ratio r₃ is derived by the following calculation.
r₃=|<C₀><C₃>′|/|<C₀><C₁>|

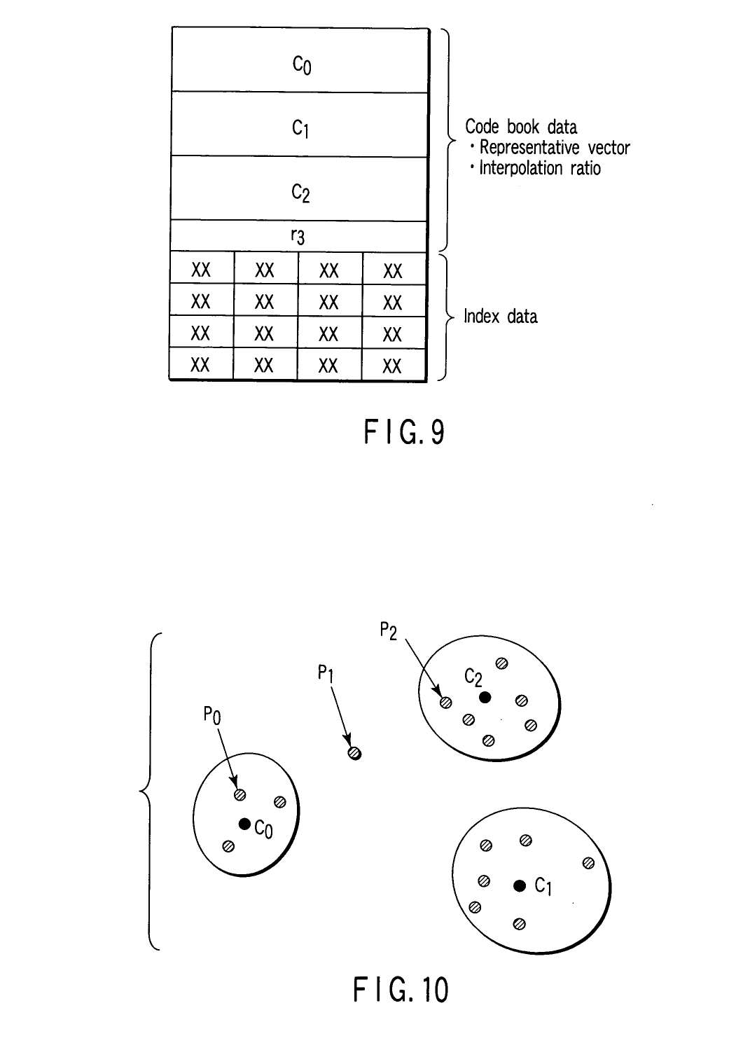

FIG. 9 shows encoded data with a code book containing thus calculated representative vectors and interpolation ratio. The method of encoding data by using an interpolation ratio is very effective for a material whose color linearly changes in accordance with a change of the viewpoint direction or light source direction. This is because the error is small even when the representative vector is approximated by using an interpolation ratio. In addition, a representative vector capable of minimizing the error even in approximation is selected as a representative vector to be approximated by an interpolation ratio.

3. <<Encoding Using Index Which Only Instructs Interpolation>>

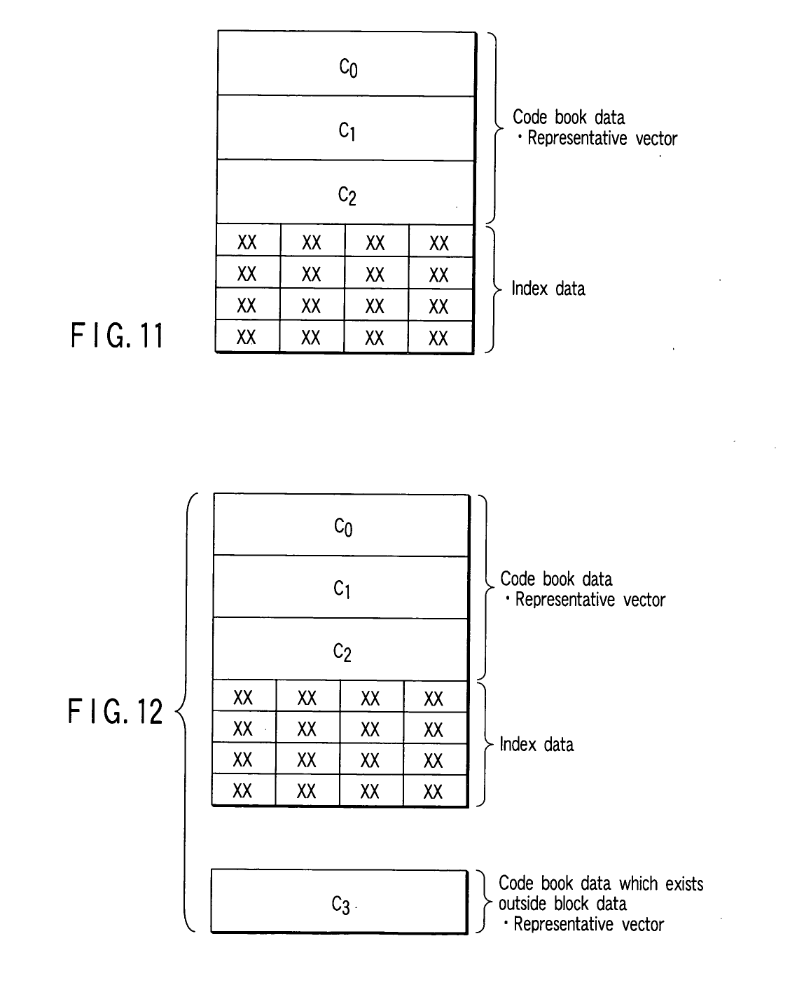

Assume that 16 pixel data (hatched circles) has a distribution shown in FIG. 10, and vectors <P₀>, <P₁>, and <P₂> are pixel data which can be loaded under the following conditions (u, v, θc, φc, θl, φl).
<P₀>:(0,0,0,0,0,0),
<P₁>:(0,0,0,10,0,0),
<P₂>:(0,0,0,20,0,0)

That is, the vectors <P₀>, <P₁>, and <P₂> are three pixel data obtained by changing φc as the condition of the viewpoint direction to 0°, 10°, and 20°. This distribution is examined before obtaining representative vectors. The color vector <P₁> is not necessary at all and can be obtained by executing interpolation based on the conditional parameters of <P₀> and <P₂>. Hence, the color vector <P₁> can be reproduced only by using index data which instructs interpolation based on the conditional parameters. That is,
<P₁>=0.5×<P₀>+0.5×<P₂>
In fact, <P₀> and <P₂> are reproduced by using the representative vectors <C₀> and <C₂>.

FIG. 11 shows the format of thus encoded block data. Index data can be assigned such that C₀ is selected if index data is “00”, C₁ for “01”, and C₂ for “10”. If the index data is “11”, the representative vector is obtained by interpolating other pixel data based on the conditional parameters. This method can be regarded as very characteristic encoding when block formation is executed based on conditional dimensions such as the viewpoint direction and light source direction.

4. <<Encoding Using Macro Block or Code Book of Entire Texture>>

Several encoding methods have been described above. In some cases, part of code book data calculated in a block data is common to part of a peripheral block data. In such a case, code book data common to a plurality of block data can be set. A set of several peripheral blocks is called a macro block. The macro block can have common code book data or code book data of the entire texture. For example, assume that the representative vectors C₀, C₁, C₂, and C₃ are obtained in a given block, and four peripheral blocks also use C₃ as a representative vector. At this time, encoding is executed by using the format shown in FIG. 12, and C₃ is stored not as a block data but as a code book data of a macro block. This encoding method must be used carefully because the decoding speed decreases although the data amount compression efficiency can be increased.

5. <<Encoding of Data Segmented for Each Vector Component>>

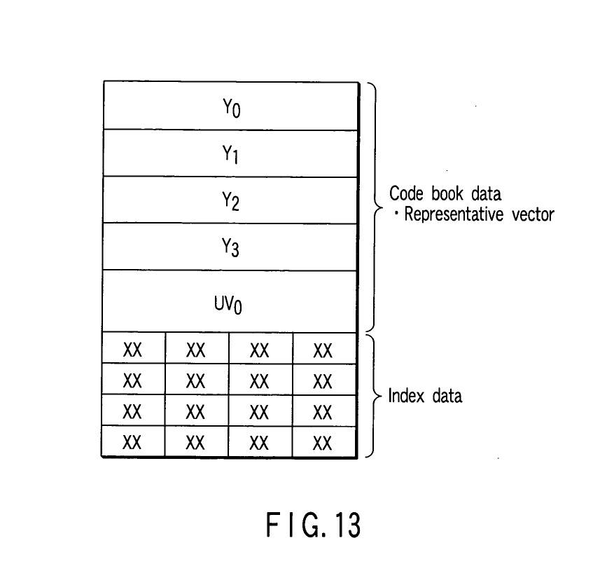

Encoding of data segmented for each vector component will be described with reference to FIG. 13. The color vector of each pixel can be expressed not only by the RGB colorimetric system but also by various colorimetric systems. A YUV colorimetric system capable of dividing a color vector into a luminance component and color difference components will be exemplified here. The color of a pixel changes variously depending on the material in accordance with the viewpoint direction or light source direction. In some materials, the luminance component changes greatly, and the color difference components change moderately. In such a case, encoding shown in FIG. 13 can be performed. As the luminance component, Y₀, Y₁, Y₂, or Y₃ is used. As the color difference component, UV₀ is used. Since the color difference component rarely changes in a block, UV₀ is always used independently of the value of index data. The luminance component largely changes in a block. Hence, four representative vectors (in this case, scalar values) are stored by the normal method, and one of them is selected based on index data.

As shown in the above example, efficiently encoding can be executed by assigning a large code amount to a component that changes greatly and assigning a small code amount to a component which changes moderately.

Several encoding formats can be set in the above-described way. More diverse encoding formats can be set by appropriately combining these encoding methods.

The encoding format can be either fixed or flexible in texture data. When a flexible format is used, an identifier that indicates the format used in each block data is necessary as header information.

<Steps S205 and S206>

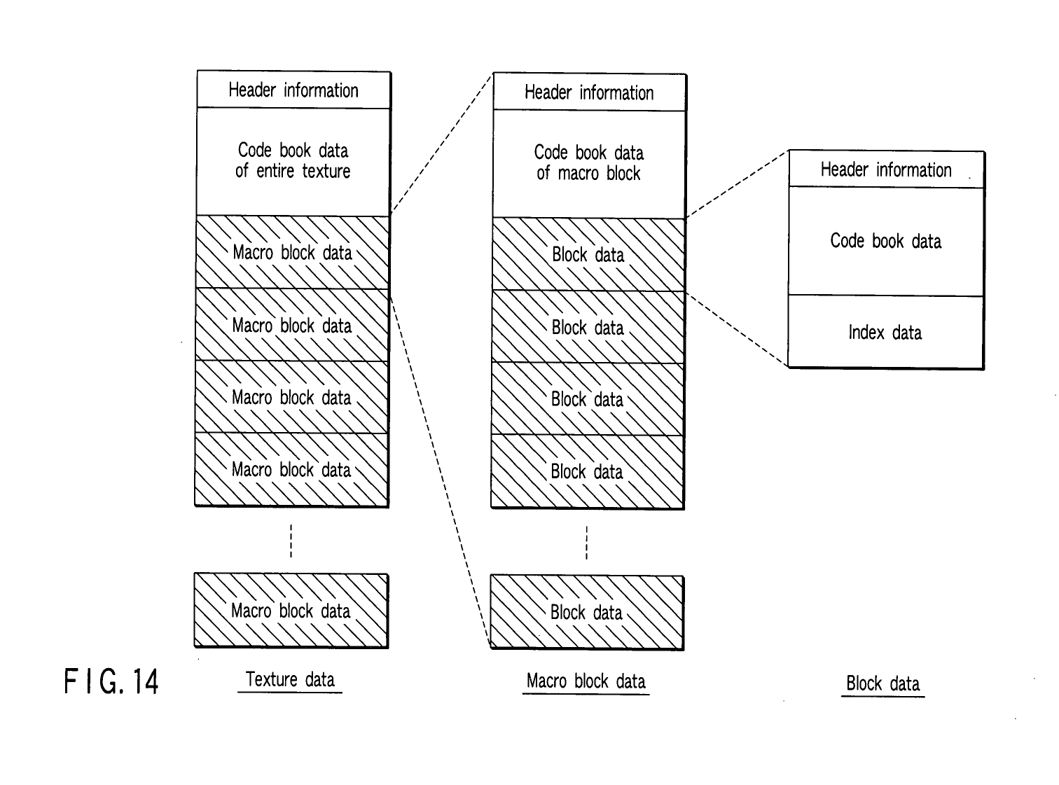

The block data concatenation unit 104 concatenates the encoded block data. When the block data encoded by various methods is concatenated, a data structure shown in FIG. 14 is obtained. Header information is stored in the encoded texture data. The header information contains a texture size, texture set acquisition conditions, and encoding format. Macro block data concatenated to the header information is stored next. If the encoding format does not change for each macro block, or no code book representing the macro blocks is set, not the macro block but the block data can be concatenated directly. If the encoding format is designated for each macro block, header information is stored at the start of each macro block. If a code book representing the macro blocks is to be set, the code book data is stored next to the header information. Then, block data present in each macro block data item is connected. If the format changes for each block, header information is stored first, and code book data and index data are stored next.

Finally, thus concatenated texture data is output (step S206).

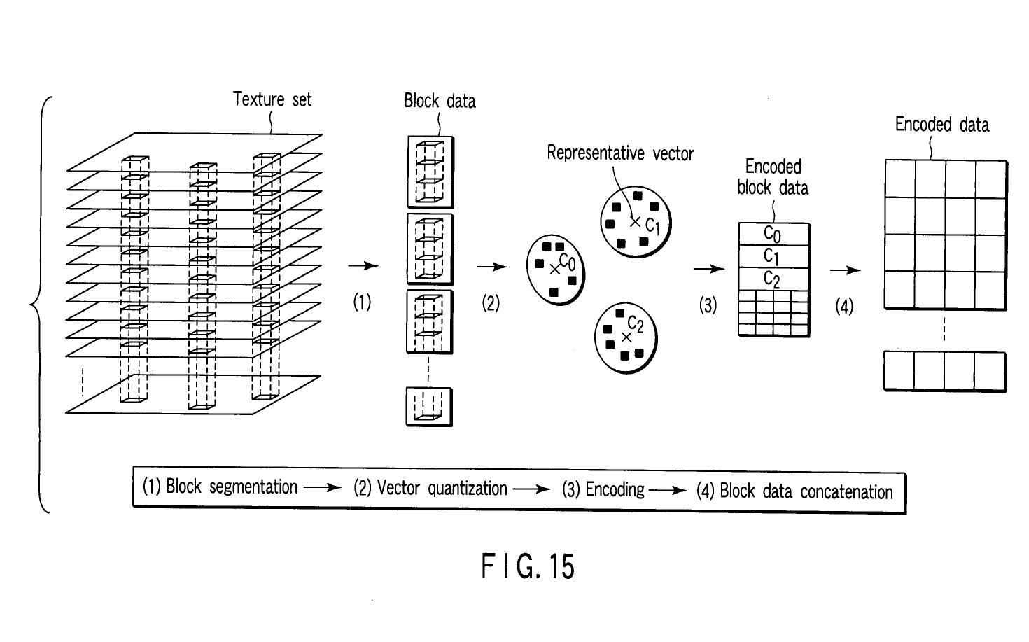

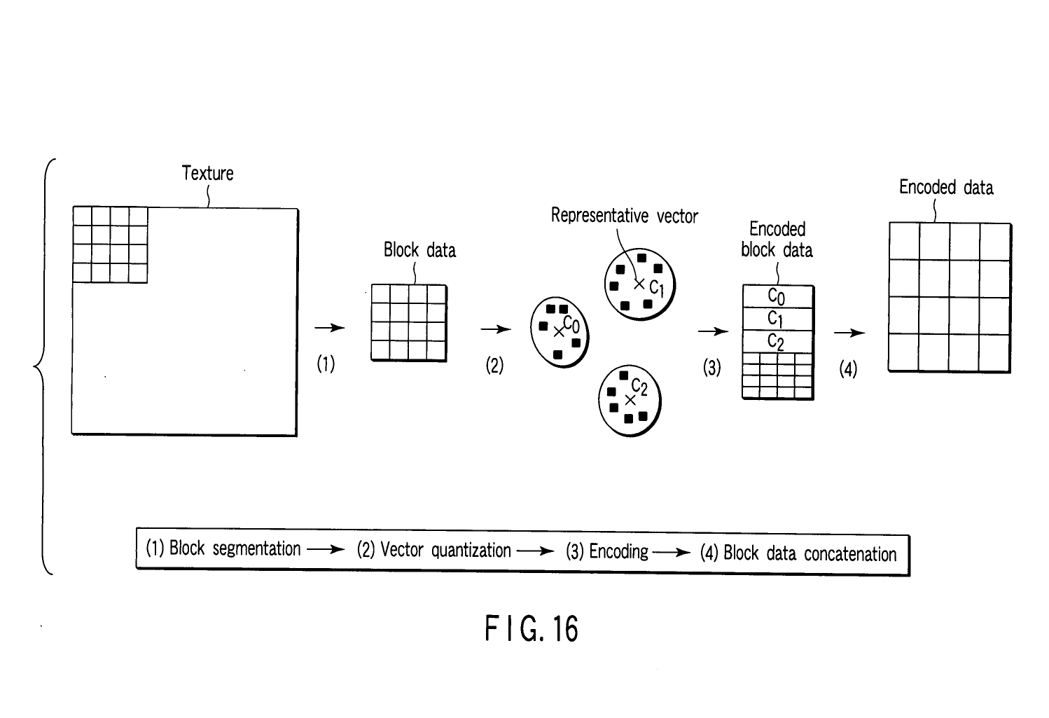

FIG. 15 shows the outline of processing of the texture encoding apparatus described with reference to FIG. 2. FIG. 16 shows the outline of processing of a conventional texture encoding apparatus in contrast with the processing of the texture encoding apparatus of this embodiment. As is apparent from comparison between FIGS. 15 and 16, the texture encoding apparatus of the embodiment of the present invention executes not only block formation of the texture space but also block formation considering the dimensions of acquisition conditions. As a consequence, according to the texture encoding apparatus of this embodiment, the frequency of texture loading with a heavy load can normally be reduced.

The representative vector calculation method in step S203 will be described next with reference to FIG. 17. For details, see, e.g., Jpn. Pat. Appln. KOKAI No. 2004-104621.

In processing after initial setting (m=4, n=1, δ) (step S1701), clustering is executed to calculate four representative vectors. In sequentially dividing a cluster into two parts, the variance of each cluster is calculated, and a cluster with a large variance is divided into two parts preferentially (step S1702). To divide a given cluster into two parts, two initial centroids (cluster centers) are determined (step S1703). A centroid is determined in accordance with the following procedures.
1. A barycenter g of the cluster is obtained.
2. An element farthest from g is defined as d₀.
3. An element farthest from d₀ is defined as d₁.
4. The 1:2 interior division points between g and d₀ and between g and d₁ are defined as C₀ and C₁, respectively.

As the distance between two elements, the Euclidean distance in the RGB 3D space is used. In loop processing in steps S1704 to S1706, the same processing as K-Means as a well-known clustering algorithm is executed.

With the above-described procedures, the four representative vectors <C₀>, <C₁>, <C₂>, and <C₃> can be obtained (step S1710).

According to the above-described first embodiment, when fixed block segmentation is to be executed in texture data, the data amount can be compressed by encoding a texture set which changes in accordance with the condition such as the viewpoint direction or light source direction. In addition, the compression effect can be increased by changing the block segmentation method in accordance with the features of the material.

(Second Embodiment)

In the second embodiment, a texture encoding apparatus which segments data based on a flexible block size. Especially, how to adaptively execute block segmentation by a block segmentation unit 102 will be described.

In this embodiment, an example of block segmentation (step S202) processing by the block segmentation unit 102 of a texture encoding apparatus shown in FIG. 1 will be described. In the first embodiment, block segmentation based on a fixed block size is executed in texture data. In the second embodiment, the block size is adaptively changed. For flexible block segmentation, for example, the following two methods can be used.

1. <<Flexible Block Segmentation Based on Variance Value>>

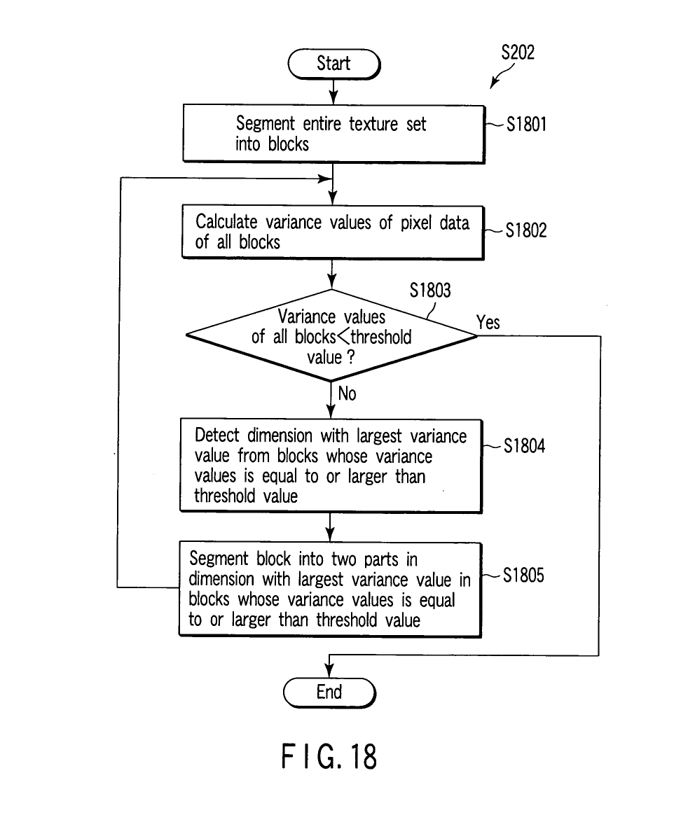

The first method is implemented without changing the apparatus arrangement shown in FIG. 1. The block segmentation unit 102 first executes processing of checking what kinds of block segmentation should be executed. FIG. 18 shows an example of processing procedures.

First, entire data of a texture set is set as one large block data (step S1801). The variance values of all pixel data present in the block data item are calculated (step S1802). It is determined whether the variance value is smaller than a preset threshold value (step S1803). If YES in step S1803, the block segmentation processing is ended without changing the current block segmentation state. If NO in step S1803, the dimension which increases the variance of the block is detected (step S1804). More specifically, a dimension whose vector difference depending on the change in the dimension is largest is selected. In that dimension, the block is segmented into two parts (step S1805). Then, the flow returns to processing in step S1802. When all segmented blocks have a variance value smaller than the threshold value, the processing is ended.

This is the most basic processing method. The block in the initial state may be a fixed block having a size predetermined to some extent. As the end condition, not the upper limit of the variance value but the minimum block size may be designated.

2. <<Flexible Block Segmentation Based on Encoding Error>>

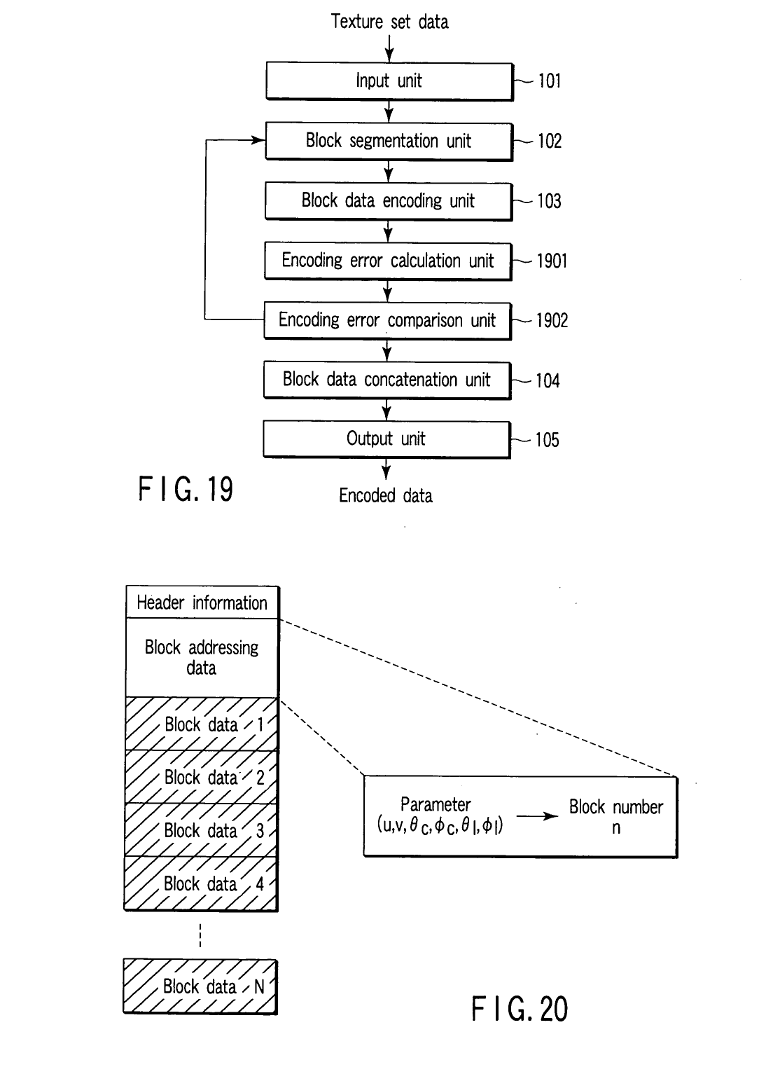

In the second method, the segmentation method is determined by using the block segmentation unit 102 and a block data encoding unit 103. In this case, the apparatus arrangement shown in FIG. 1 must be changed slightly. FIG. 19 shows the changed apparatus arrangement. Unlike the apparatus shown in FIG. 1, an encoding error calculation unit 1901 and encoding error comparison unit 1902 are added to the succeeding stage of the block data encoding unit 103. The same reference numerals as those of the already described components denote the same parts in FIG. 19, and a description thereof will be omitted.

The encoding error calculation unit 1901 executes the same processing as the block data encoding unit 103 and calculates the encoding error by comparing original data with decoded data.

The encoding error comparison unit 1902 compares the encoding error calculated by the encoding error calculation unit 1901 with an allowance condition that indicates the allowable range of the encoding error. The allowance condition defines that, e.g., the encoding error is smaller than a threshold value. In this case, a block whose encoding error calculated by the encoding error calculation unit 1901 is smaller than the threshold value is output to a block data concatenation unit 104. For a block whose encoding error is equal to or larger than the threshold value, the processing returns to the block segmentation unit 102. That is, the block segmentation unit 102 segments the block into smaller blocks, and then, encoding is executed again. In other words, each block data is segmented into data with a data amount smaller than the preceding time and encoded again.

Two flexible block segmentation methods have been described above. When blocks are segmented by such a method, “block addressing data” indicating a block to which pixel data belongs is necessary because no regular block segmentation is done. FIG. 20 shows an encoded data structure containing block addressing data. For the sake of simplicity, the concept of macro blocks and the code book data outside the block data is excluded. Block addressing data is stored between header information and block data. The block addressing data stores table data which indicates a correspondence between parameters to load a pixel data and an ID number (block number) assigned to the block data. The block addressing data plays an important role to access a block data in processing of decoding data encoded based on a flexible block size, which will be described later in the fourth embodiment.

According to the above-described second embodiment, when flexible block segmentation is to be executed in texture data, the data amount can be compressed by encoding a texture set which changes in accordance with the condition such as the viewpoint direction or light source direction.

The data of a texture set encoded by the texture encoding apparatus according to the first or second embodiment of the present invention can be stored in a database and made open to the public over a network.

(Third Embodiment)

In the third embodiment, data of a texture set encoded based on a fixed block size is input. How to decode the input encoded data and map it to graphics data will be described. In this embodiment, an example of a series of processing operations of a texture decoding apparatus (including a mapping unit) will be described.

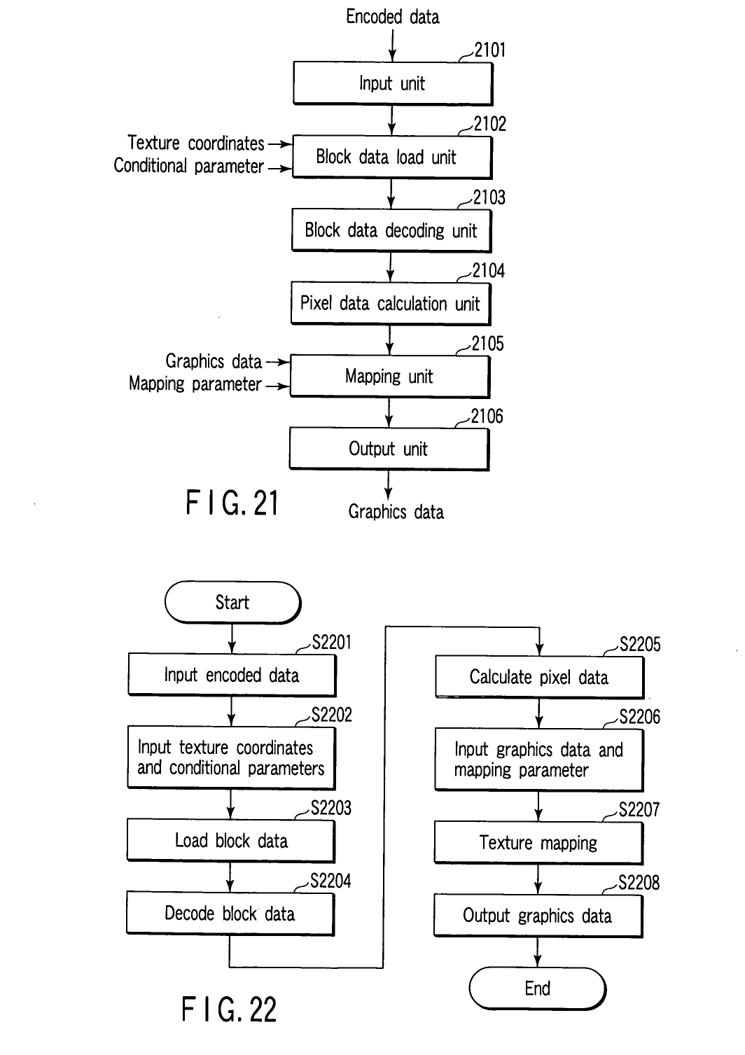

The texture decoding apparatus according to this embodiment will be described with reference to FIG. 21.

The outline will be described first. The texture decoding apparatus shown in FIG. 21 receives texture data encoded by the texture encoding apparatus described in the first or second embodiment, decodes specific pixel data based on designated texture coordinates and conditional parameters, and maps the decoded data to graphics data.

The texture decoding apparatus comprises an input unit 2101, block data load unit 2102, block data decoding unit 2103, pixel data calculation unit 2104, mapping unit 2105, and output unit 2106.

The input unit 2101 inputs encoded data of a texture set acquired or created under a plurality of different conditions.

The block data load unit 2102 receives texture coordinates which designate a pixel position and conditional parameters which designate conditions and loads block data containing the designated data from the encoded data input by the input unit 2101.

The block data decoding unit 2103 decodes the block data loaded by the block data load unit 2102 to original data before it is encoded by the block data encoding unit 103 of the texture encoding apparatus described in the first or second embodiment.

The pixel data calculation unit 2104 calculates pixel data based on the data decoded by the block data decoding unit 2103.

The mapping unit 2105 receives graphics data as a texture mapping target and a mapping parameter which designates the texture mapping method and maps the pixel data calculated by the pixel data calculation unit 2104 to the received graphics data based on the received mapping parameter.

The output unit 2106 outputs the graphics data mapped by the mapping means.

The operation of the texture decoding apparatus shown in FIG. 21 will be described next with reference to FIG. 22.

<Step S2201>

In the texture decoding apparatus of this embodiment, first, the input unit 2101 inputs encoded data of a texture set. At the time of input, the input unit 2101 reads out the header information of the encoded data and checks the texture size, texture set acquisition conditions, and encoding format.

<Step S2202>

Next, the block data load unit 2102 receives texture coordinates and conditional parameters. These parameters are obtained from the texture coordinates set for each vertex of graphics data and scene information such as the camera position or light source position.

<Step S2203>

The block data load unit 2102 loads a block data. In this embodiment, block segmentation is executed by using a fixed block size. Hence, the block data load unit 2102 can access a block data containing pixel data based on received texture coordinates u and v and conditional parameters θc, φc, θl, and φl.

Note that in some cases, the obtained conditional parameters do not completely match the original conditions for texture acquisition. In such a case, it is necessary to extract all existing pixel data with close conditions and interpolate them. For example, the condition of the closest texture sample smaller than θc is defined as θc0, and the condition of the closest texture sample equal to or larger than θc is defined as θc1. Similarly, φc0, φc1, θl0, θl1, φl0, and φl1 are defined. All pixel data which satisfy these conditions is loaded. The pixel data to be loaded is the following 16 pixel data c0 to c15.

c0=getPixel(θc0, φc0, θl0, φl0, us, vs)

c1=getPixel(θc0, φc0, θl0, φl1, us, vs)

c2=getPixel(θc0, φc0, θl1, φl0, us, vs)

c3=getPixel(θc0, φc0, θl1, φl1, us, vs)

c4=getPixel(θc0, φc1, θl0, φl0, us, vs)

c5=getPixel(θc0, φc1, θl0, φl1, us, vs)

c6=getPixel(θc0, φc1, θl1, φl0, us, vs)

c7=getPixel(θc0, φc1, θl1, φl1, us, vs)

c8=getPixel(θc1, φc0, θl0, φl0, us, vs)

c9=getPixel(θc1, φc0, θl0, φl1, us, vs)

c10=getPixel(θc1, φc0, θl1, φl0, us, vs)

c11=getPixel(θc1, φc0, θl1, φl1, us, vs)

c12=getPixel(θc1, φc1, θl0, φl0, us, vs)

c13=getPixel(θc1, φc1, θl0, φl1, us, vs)

c14=getPixel(θc1, φc1, θl1, φl0, us, vs)

c15=getPixel(θc1, φc1, θl1, φl1, us, vs)
where us and vs are texture coordinates input in this example, and getPixel is a function to extract pixel data based on the conditional parameters and the 6-dimensional parameters of the texture coordinates. When the 16 pixel data is interpolated in the following way, final the pixel data c can be loaded.

$$\begin{matrix}\underline{c} = ( 1 - ɛ 0 ) \times ( 1 - ɛ 1 ) \times ( 1 - ɛ 2 ) \times ( 1 - ɛ 3 ) \times c 0 + \\ ( 1 - ɛ 0 ) \times ( 1 - ɛ 1 ) \times ( 1 - ɛ 2 ) \times ɛ 3 \times c 1 + \\ ( 1 - ɛ 0 ) \times ( 1 - ɛ 1 ) \times ɛ 2 \times ( 1 - ɛ 3 ) \times c 2 + \\ ( 1 - ɛ 0 ) \times ( 1 - ɛ 1 ) \times ɛ 2 \times ɛ 3 \times c 3 + \\ ( 1 - ɛ 0 ) \times ɛ 1 \times ( 1 - ɛ 2 ) \times ( 1 - ɛ 3 ) \times c 4 + \\ ( 1 - ɛ 0 ) \times ɛ 1 \times ( 1 - ɛ 2 ) \times ɛ 3 \times c 5 + \\ ( 1 - ɛ 0 ) \times ɛ 1 \times ɛ 2 \times ( 1 - ɛ 3 ) \times c 6 + \\ ( 1 - ɛ 0 ) \times ɛ 1 \times ɛ 2 \times ɛ 3 \times c 7 + \\ ɛ 0 \times ( 1 - ɛ 1 ) \times ( 1 - ɛ 2 ) \times ( 1 - ɛ3 ) \times c 8 + \\ ɛ 0 \times ( 1 - ɛ 1 ) \times ( 1 - ɛ 2 ) \times ɛ 3 \times c 9 + \\ ɛ 0 \times ( 1 - ɛ 1 ) \times ɛ 2 \times ( 1 - ɛ 3 ) \times c 10 + \\ ɛ 0 \times ( 1 - ɛ 1 ) \times ɛ 2 \times ɛ 3 \times c 11 + \\ ɛ 0 \times ɛ 1 \times ( 1 - ɛ 2 ) \times ( 1 - ɛ 3 ) \times c 12 + \\ ɛ 0 \times ɛ 1 \times ( 1 - ɛ 2 ) \times ɛ 3 \times c 13 + \\ ɛ 0 \times ɛ 1 \times ɛ 2 \times ( 1 - ɛ 3 ) \times c 14 + \\ ɛ 0 \times ɛ 1 \times ɛ 2 \times ɛ 3 \times c 15\end{matrix}$$

The interpolation ratios ε0, ε1, ε2, and ε3 are calculated in the following way.
ε0=(θc−θc0)/(θc1−θc0)
ε1=(φc−φc0)/(φc1−φc0)
ε2=(θl−θl0)/(θl1−θl0)
ε3=(φl−φl0)/(φl1−φl0)

As described above, to calculate one pixel data, 16 pixel data must be loaded and interpolated. The noteworthy point is that the encoded data proposed in this embodiment contains pixel data of adjacent conditions is present in the same block data. Hence, all the 16 pixel data is sometimes contained in the same block data. In that case, interpolated pixel data can be calculated only by loaded one block data. In some cases, however, 2 to 16 block data must be extracted. Hence, the number of times of extraction must be changed in accordance with the conditional parameters.

As is known, the number of texture load instructions (processing of extracting a pixel data or a block data) generally influences the execution rate in the graphics LSI. When the number of texture load instructions is made as small as possible, the rendering speed can be increased. Hence, the encoding method proposed in the embodiment of the present invention is a method to implement faster texture mapping.

<Step S2204>

The block data decoding unit 2103 decodes the block data. The method of decoding a block data and extracting specific a pixel data changes slightly depending on the encoding format. Basically, however, the decoding method is determined by referring to the index data of a pixel to be extracted. A representative vector indicated by the index data is directly extracted, or a vector changed by the vector difference from a reference vector is extracted. Alternatively, a vector obtained by interpolating two vectors is extracted. The vectors are decoded based on a rule determined at the time of encoding.

<Step S2205>

The pixel data calculation unit 2104 extracts pixel data. As described above, 16 pixel data is interpolated by using the above-described equations.

<Steps S2206, S2207, and S2208>

The mapping unit 2105 receives graphics data and mapping parameter (step S2206) and maps pixel data in accordance with the mapping parameter (step S2207). Finally, the output unit 2106 outputs the graphics data which has undergone texture mapping (step S2208).

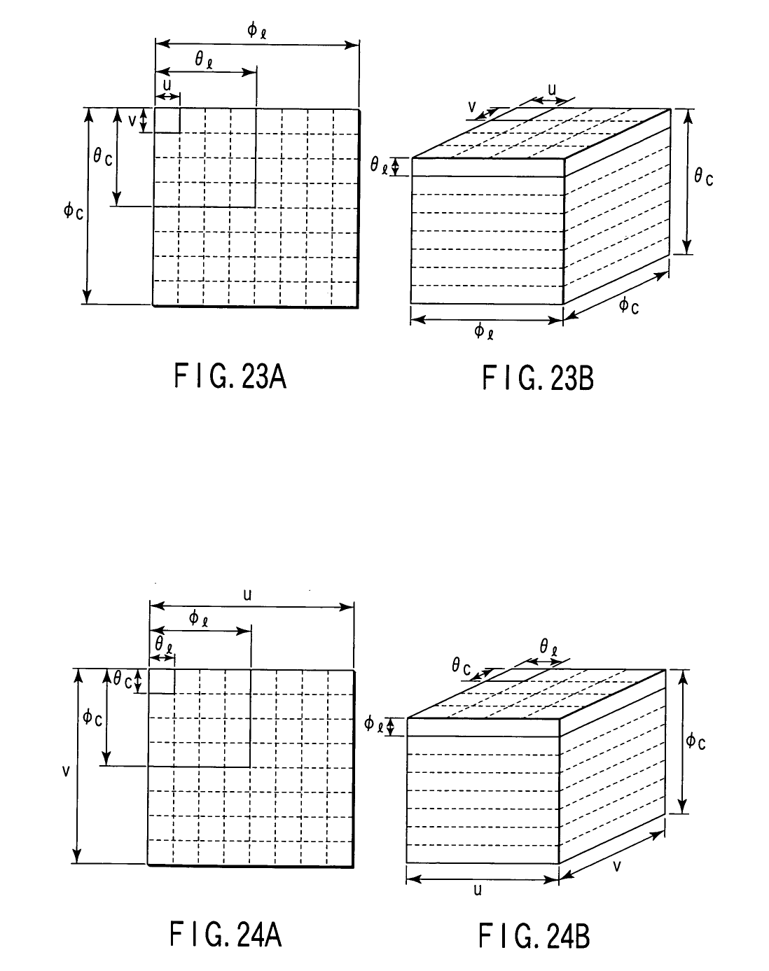

A change in texture mapping processing speed (rendering performance) depending on the texture layout method will be described next with reference to FIGS. 23A, 23B, 24A, 24B, 25A, 25B, 26A, and 26B.

The rendering performance on the graphics LSI largely depends on the texture layout method. In this embodiment, a texture expressed by 6-dimensional parameters (u, v, θc, φc, θl, φl) is taken as an example of a higher-order texture. The number of times of pixel data loading or the hit ratio to a texture cache on hardware changes depending on the layout of texture data stored in the memory of the graphics LSI. The rendering performance also changes depending on the texture layout. Even in encoding a higher-order texture, it is necessary to segment and concatenate a block data in consideration of this point. This also applies to an uncompressed higher-order texture.

The difference between the texture layout methods will be described below. FIG. 23A shows a 2D texture in which textures having the sum of changes in the u and v directions (so-called normal textures) are laid out as tiles in accordance with a change in the θ direction and also laid out as tiles in accordance with a change in the φ direction. In this layout method, pixel data corresponding to the changes in the u and v directions is stored at adjacent pixel positions. Hence, interpolated pixel data can be extracted at high speed by using the bi-linear function of the graphics LSI. However, if a higher-order texture is generated, and a higher-order texture of an arbitrary size is expressed from a small texture sample, the u and v positions are determined by indices. No consecutive u or v values are always designated. Hence, the bi-linear function of the graphics LSI cannot be used.

On the other hand, pixel data corresponding to the change in θ or φ direction is stored at separate pixel positions. Hence, pixel data must be extracted a plurality of times by calculating the texture coordinates, and interpolation calculation must be done on software. The texture cache hit ratio will be considered. The hit ratio is determined depending on the proximity of texture coordinates referred to in obtaining an adjacent pixel value of a frame to be rendered. Hence, the texture cache can easily be hit in the layout method shown in FIG. 23A. This is because adjacent pixels in the u and v directions have similar θ or φ conditions in most cases.

FIG. 23B shows a 3D texture in which textures having the sum of changes in the u and v directions are laid out as tiles in accordance with a change in the φ direction and also stacked in the layer direction (height direction) in accordance with a change in the θ direction. In this layout, interpolation in the θ1 direction can also be done by hardware in addition to bi-linear in the u and v directions. That is, interpolation calculation using the tri-linear function of a 3D texture can be executed. Hence, the frequency of texture loading can be reduced as compared to FIG. 23A. The texture cache hit ratio is not so different from FIG. 23A. Since the frequency of texture loading decreases, faster rendering is accordingly possible.

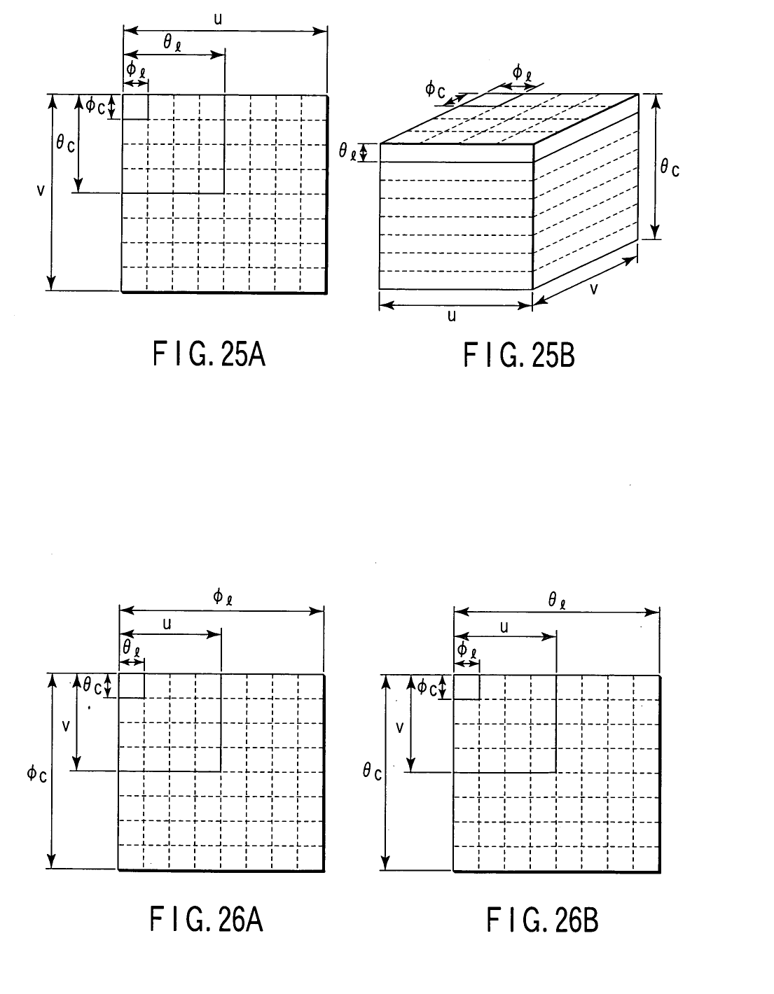

FIGS. 24A and 25A show 2D textures in which textures having the sum of changes in the θ and φ directions are laid out as tiles in accordance with changes in the φ and θ directions and also laid out as tiles in accordance with changes in the u and v directions. In these layout methods, pixel data corresponding to the changes in the θ and φ directions is stored at adjacent pixel positions. Hence, interpolated pixel data can be extracted at high speed by using the bi-linear function of the graphics LSI. On the other hand, pixel data corresponding to the changes in the φ direction, θ direction, or u or v direction is stored at separate pixel positions. Hence, pixel data must be extracted a plurality of times by calculating the texture coordinates, and interpolation calculation must be done in software.

The texture cache hit.ratio is lower than in the layout method shown in FIG. 23A because pixel data corresponding to the changes in the u or v direction is stored at separate pixel positions. To improve it, the layout is changed to that shown in FIG. 26A or 26B. Then, the texture cache hit ratio increases, and the rendering performance can be improved. Because tiles corresponding to the changes in the u or v direction are laid out at closer positions, closer texture coordinates are referred to in obtaining an adjacent pixel value of a frame to be rendered.

FIGS. 24B and 25B show 3D textures in which textures having the sum of changes in the θ and φ directions are laid out as tiles in accordance with changes in the u and v directions and also stacked in the layer direction (height direction) in accordance with changes in the φ and θ directions. In these layout methods, interpolation in the φ1 and θ1 directions can also be done by hardware in addition to bi-linear in the θ and φ directions. That is, interpolation calculation using the tri-linear function of a 3D texture can be executed. Hence, referring to FIGS. 24B and 25B, the frequency of texture loading can be reduced as compared to FIGS. 25A and 26A. The texture cache hit ratio can be made higher as compared to FIGS. 25A and 26A. In the 2D texture, tiles corresponding to the changes in u and v directions are at separate position. In the 3D texture, pixel data with uv close to the layer direction (height direction) and close θ1 or φ1 is present.

As described above, the frequency of texture loading or texture cache hit ratio changes depending on the texture layout method so that the rendering performance changes greatly. When the texture layout method is determined in consideration of this characteristic, and block formation method determination, encoding, and block data concatenation are executed, more efficient higher-order texture mapping can be implemented.

For example, in FIG. 24A, when data is segmented into blocks two-dimensionally in the θc and θl directions and encoded, the encoded data can be stored on the memory of the graphics LSI by the layout method as shown in FIG. 24A. In mapping, the bi-linear function of the hardware can be used.

According to the above-described third embodiment, when data of a texture set encoded based on a fixed block size is to be input, the texture mapping processing speed on the graphics LSI can be increased by encoding a texture set which changes in accordance with the condition such as the viewpoint direction or light source direction.

(Fourth Embodiment)

In the fourth embodiment, processing of a texture decoding apparatus (including a mapping unit) when data of a texture set encoded based on a flexible block size is input will be described. Especially, how to cause a block data load unit to access a block data will be described.

The operation of the texture decoding apparatus according to this embodiment will be described. The blocks included in the texture decoding apparatus are the same as in FIG. 21. An example of processing of block data load (step S2203) executed by a block data load unit 2102 will be described.

In the third embodiment, texture data encoded based on a fixed block size is processed. In the fourth embodiment, texture data encoded based on a flexible block size is processed. For example, the following two methods can be used to appropriately access and load a block data in texture data encoded based on a flexible block size.

1. <<Block Data Load Using Block Addressing Data>>

As described in the second embodiment, when encoding based on a flexible block size is executed, block addressing data is contained in encoded data. Hence, after texture coordinates and conditional parameters are input, the block data load unit 2102 can check a block data to be accessed by collating the input six-dimensional parameters with the block addressing data. Processing after access to designated the block data is the same as that described in the third embodiment.

2. <<Block Data Load Using Encoded Data Conversion>>

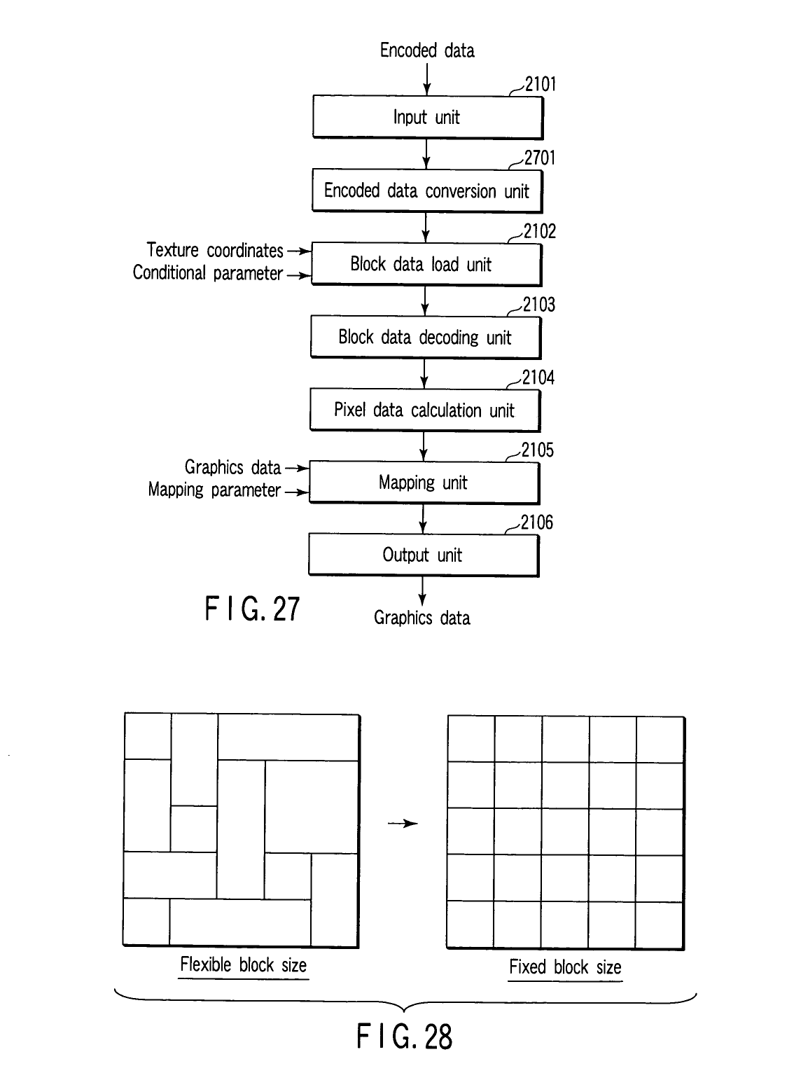

In the second method, the block data is loaded after encoded data conversion processing. In this case, the apparatus arrangement shown in FIG. 22 must be changed slightly. FIG. 27 shows the changed apparatus arrangement. Only an encoded data conversion unit 2701 in FIG. 27 is different from FIG. 21. The encoded data conversion unit 2701 is set at the preceding stage of the block data load unit 2102 and at the succeeding stage of an input unit 2101.

The encoded data conversion unit 2701 converts a texture data encoded based on a flexible block size into an encoded data of a fixed block size. The encoded data conversion unit 2701 accesses a block data of a flexible size by using block addressing data. After conversion to a fixed size, the block addressing data is unnecessary and is therefore deleted.

FIG. 28 schematically shows conversion from a flexible block size to a fixed block size. To convert a block segmented based on a flexible size to a larger size, calculation must be executed in the same amount as in re-encoding processing. On the other hand, conversion to a size smaller than a block segmented based on the flexible size can be implemented by calculation as simple as decoding processing. Hence, the latter conversion is executed. Processing after conversion to encoded data of a fixed size is the same as that described in the third embodiment.

Two block data load methods in encoded data of a flexible block size have been described. In the method using block addressing data, mapping can be done in a small data amount. However, in every pixel processing, block addressing data must be referred to. This indicates that the number of texture load instructions increases by one, affecting the rendering speed.

In the method using encoded data conversion, conversion to data of a fixed block size is done immediately before storing the data in the internal video memory of the graphics LSI. Hence, rendering can be executed at a relatively high speed. However, when the fixed block size is used, the data amount becomes relatively large. Since all these methods have both merits and demerits, they must appropriately be selected in accordance with the complexity of the texture material or the specifications of the graphics LSI.

According to the above-described fourth embodiment, when data of a texture set encoded based on a flexible block size is to be input, the texture mapping processing speed on the graphics LSI can be increased by encoding a texture set which changes in accordance with the condition such as the viewpoint direction or light source direction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A texture encoding apparatus comprising:
a texture data acquisition unit configured to acquire texture data of a texture set provided under a plurality of different conditions;
a block segmentation unit configured to segment the texture data into a plurality of block data items each of which contains a plurality of pixel data items whose values corresponding to the conditions fall within a first range and whose pixel positions fall within a second range in the texture set;
a block data encoding unit configured to encode each of the block data items to produce a plurality of encoded block data items; and
a block data concatenation unit configured to concatenate the encoded block data items to generate an encoded data item of the texture set.

2. The apparatus according to claim 1, wherein the block segmentation unit forms, based on the conditions and a pixel data item in which a pixel position have a value, a block which contains the pixel data item and a constant number of pixel data items which have the pixel positions and whose conditions are changed in a range.

3. The apparatus according to claim 1, wherein the block segmentation unit comprises:
a calculation unit configured to calculate variance values of the pixel data items;
a comparison unit configured to compare each of the variance values with a given value to determine whether each of the variance values is smaller than the given value;
a detection unit configured to, when the block includes a pixel data item having a variance value not less than the given value, detect one dimension of dimensions of the pixel data item, the one dimension corresponding to one of the conditions and having a largest variance value; and
a division unit configured to divide the texture data into two parts in the detected one dimension,
the calculation unit calculating a variance value for each of the texture data each divided into the two parts.

4. The apparatus according to claim 1, wherein the block data encoding unit encodes each of the block data items by vector quantization.

5. The apparatus according to claim 1, wherein the block data encoding unit comprises:
a vector calculation unit configured to calculate a plurality of representative vectors from each of the block data items by vector quantization; and
a creation unit configured to create a plurality of code book data items containing the plurality of representative vectors corresponding to each of the block data items, and index data items each serving as information representing correspondence between each of the representative vectors and each of the pixel data items in each of the block data items.

6. The apparatus according to claim 1, wherein the block data encoding unit comprises a creation unit configured to create a plurality of code book data items to be used as original data for decoding, and a plurality of index data items for identifying a decoding method of each pixel, and the encoded block data contains the code book data items and the index data items.

7. The apparatus according to claim 6, wherein the creation unit contains in each of the code book data items representative vectors which indicate representative pixel data items in the block data items, vector differences which hold differences from a representative vector, and interpolation ratios to interpolate the representative vectors.

8. The apparatus according to claim 7, wherein the creation unit contains in the index data items indices representing the representative vectors, indices representing vectors obtained by adding the vector differences to a representative vector, indices representing interpolated vectors of representative vectors, which are obtained by using the interpolation ratios, and indices representing interpolation from neighboring pixel data items without indicating a decoding method.

9. The apparatus according to claim 5, wherein the block data encoding unit comprises:
an attachment unit configured to attach the code book data items to a macro block or the texture set, the macro block containing a plurality of blocks; and
a creation unit configured to create a plurality of index data items of each pixel, the index data items indicating a decoding method using one of the code book data items of each macro block and the code book data items of the texture set, the index data items being added to the code book data items in the block.

10. The apparatus according to claim 5, wherein the block data encoding unit encodes the block data items in which components of a vector of each of the pixel data items includes one of color information, transparency information, normal vector information, depth information, illumination effect information, and vector information for creating a graphics data item.

11. The apparatus according to claim 10, wherein the block data encoding unit vectorizes a combination of at least two different components of the components, and assigns the index data items to the components or assigns the code book data items to the components in accordance with a characteristic of a change in each of the components.

12. The apparatus according to claim 10, wherein the block data encoding unit assigns a code amount to one of the components, which changes by not less than a variation, larger than a code amount assigned to a component in the components which changes by less than the variation.

13. A texture encoding apparatus comprising:
a texture data acquisition unit configured to acquire texture data of a texture set provided under a plurality of different conditions;
a block segmentation unit configured to segment the texture data into a plurality of block data items each of which contains a plurality of pixel data items whose values corresponding to the conditions fall within a first range and whose pixel positions fall within a second range in the texture set;
a block data encoding unit configured to encode each of the block data items to produce a plurality of encoded block data items;
an error calculation unit configured to calculate an encoding error of each of the encoded block data items;
a comparison unit configured to compare, for each of the encoded block data items, the calculated encoding error with an allowance condition indicating an encoding error within a range; and
a block data concatenation unit configured to concatenate the encoded block data items whose calculated encoding errors satisfy the allowance condition,
wherein each of the block data items whose calculated encoding error fails to satisfy the allowance condition is segmented into a block data item having a smaller data amount than the segmented block data by the block segmentation unit.

14. The apparatus according to claim 13, wherein the block data encoding unit encodes each of the block data items by vector quantization.

15. The apparatus according to claim 13, wherein the block data encoding unit comprises:
a vector calculation unit configured to calculate a plurality of representative vectors from each of the block data items by vector quantization; and
a creation unit configured to create a plurality of code book data items containing the plurality of representative vectors corresponding to each of the block data items, and index data items each serving as information representing correspondence between each of the representative vectors and each of the pixel data items in each of the block data items.

16. The apparatus according to claim 13, wherein the block data encoding unit comprises a creation unit configured to create a plurality of code book data items to be used as original data for decoding, and a plurality of index data items for identifying a decoding method of each pixel, and the encoded block data contains the code book data items and the index data items.

17. The apparatus according to claim 16, wherein the creation unit contains in each of the code book data items representative vectors which indicate representative pixel data items in the block data items, vector differences which hold differences from a representative vector, and interpolation ratios to interpolate the representative vectors.

18. The apparatus according to claim 17, wherein the creation unit contains in the index data items indices representing the representative vectors, indices representing vectors obtained by adding the vector differences to a representative vector, indices representing interpolated vectors of representative vectors, which are obtained by using the interpolation ratios, and indices representing interpolation from neighboring pixel data items without indicating a decoding method.

19. The apparatus according to claim 15, wherein the block data encoding unit comprises:
an attachment unit configured to attach the code book data items to a macro block or the texture set, the macro block containing a plurality of blocks; and
a creation unit configured to create a plurality of index data items of each pixel, the index data items indicating a decoding method using one of the code book data items of each macro block and the code book data items of the texture set, the index data items being added to the code book data items in the block.

20. The apparatus according to claim 15, wherein the block data encoding unit encodes the block data items in which components of a vector of each of the pixel data items includes one of color information, transparency information, normal vector information, depth information, illumination effect information, and vector information for creating a graphics data item.

21. The apparatus according to claim 20, wherein the block data encoding unit vectorizes a combination of at least two different components of the components, and assigns the index data items to the components or assigns the code book data items to the components in accordance with a characteristic of a change in each of the components.

22. The apparatus according to claim 20, wherein the block data encoding unit assigns a code amount to one of the components, which changes by not less than a variation, larger than a code amount assigned to a component in the components which changes by less than the variation.

23. A texture decoding apparatus comprising:
an encoded data acquisition unit configured to acquire encoded data of a texture set provided under a plurality of different conditions;
a designated data acquisition unit configured to acquire a plurality of texture coordinates for designating pixel positions and a conditional parameter for designating a condition in the conditions;
a block data load unit configured to load, from the encoded data, a block data item corresponding to the texture coordinates and the conditional parameter;
a block data decoding unit configured to decode the loaded block data item; and
a pixel data calculation unit configured to calculate a plurality of pixel data items based on the decoded data item.

24. The apparatus according to claim 23, further comprising:
an acquisition unit configured to acquire a graphics data item as a target of a texture mapping, and a mapping parameter which designates a method of the texture mapping;
a mapping unit configured to map the pixel data items to the graphics data item by referring to the mapping parameter; and
a graphics data output unit configured to output the mapped graphics data item.

25. The apparatus according to claim 23, wherein
the encoded data acquisition unit acquires the data item encoded by a texture encoding apparatus using the block segmentation unit of claim 2, and
the block data load unit accesses the block data item in accordance with block formation of claim 2.

26. The apparatus according to claim 23, wherein
the encoded data acquisition unit acquires the data item encoded by a texture encoding apparatus using the block segmentation unit of claim 3, and
the block data load unit acquires, in addition to the texture coordinates and the conditional parameter, a block addressing data item as a table data item to determine the block data item to be accessed based on the texture coordinates and the conditional parameter, and loads the block data item by determining the block data item, based on the texture coordinates, the conditional parameter, and the block addressing data item.

27. The apparatus according to claim 23, wherein the block data load unit accesses at least two block data items if the conditional parameter to designate the condition fails to coincide with an acquisition condition or a creation condition in the encoded texture set, determines number of block data items to be accessed, based on the texture coordinates, the conditional parameter, and a block addressing data item as a table data item to determine the block data item to be accessed based on the texture coordinates and the conditional parameter, and loads all necessary block data items, and when the encoded data is formed in a block, loads the pixel data items corresponding to the conditions.

28. A texture decoding apparatus comprising:
an encoded data acquisition unit configured to acquire encoded data of a texture set provided under a plurality of different conditions;
an encoded data conversion unit configured to convert a size of a block contained in the encoded data into a fixed block size;
a designated data acquisition unit configured to acquire a plurality of texture coordinates for designating pixel positions and a conditional parameter for designating a condition in the conditions;
a block data load unit configured to load, from the converted encoded data, a block data item corresponding to the texture coordinates and the conditional parameter;
a block data decoding unit configured to decode the loaded block data item; and
a pixel data calculation unit configured to calculate a plurality of pixel data items based on the decoded block data item.

29. The apparatus according to claim 28, wherein the encoded data conversion unit converts the encoded data which is segmented according to claim 3 into the encoded data which is formed in a block according to claim 2.

30. The apparatus according to claim 28, further comprising:
an acquisition unit configured to acquire a graphics data item as a target of a texture mapping, and a mapping parameter which designates a method of the texture mapping;
a mapping unit configured to map the pixel data items to the graphics data item by referring to the mapping parameter; and
a graphics data output unit configured to output the mapped graphics data item.

31. The apparatus according to claim 28, wherein
the encoded data acquisition unit acquires the data encoded by a texture encoding apparatus using the block segmentation unit of claim 2, and
the block data load unit accesses the block data item in accordance with block formation of claim 2.

32. The apparatus according to claim 28, wherein
the encoded data acquisition unit acquires the data encoded by a texture encoding apparatus using the block segmentation unit of claim 3, and
the block data load unit acquires, in addition to the texture coordinates and the conditional parameter, a block addressing data item as a table data item to determine the block data item to be accessed based on the texture coordinates and the conditional parameter, and loads the block data item by determining the block data item, based on the texture coordinate, the conditional parameter, and the block addressing data.

33. The apparatus according to claim 28, wherein the block data load unit accesses at least two block data items if the conditional parameter to designate the condition fails to coincide with an acquisition condition or a creation condition in the encoded texture set, determines number of block data items to be accessed, based on the texture coordinates, the conditional parameter, and a block addressing data item as a table data item to determine the block data item to be accessed based on the texture coordinates and the conditional parameter, and loads all necessary block data items, and when the encoded data is formed in a block, loads the pixel data items corresponding to the conditions.

34. A texture encoding method comprising:
acquiring texture data of a texture set provided under a plurality of different conditions;
segmenting the texture data into a plurality of block data items each of which contains a plurality of pixel data items whose values corresponding to the conditions fall within a first range and whose pixel positions fall within a second range in the texture set;
encoding each of the block data items; and
concatenating the encoded block data items to generate an encoded data item of the texture set.

35. A texture encoding method comprising:
acquiring texture data of a texture set provided under a plurality of different conditions;
segmenting the texture data into a plurality of block data items each of which contains a plurality of pixel data items whose values corresponding to the conditions fall within a first range and whose pixel positions fall within a second range in the texture set;
encoding each of the block data items to produce a plurality of encoded block data items;
calculating an encoding error of each of the encoded block data items;
comparing, for each of the encoded block data items, the calculated encoding error with an allowance condition indicating an encoding error within a range; and
concatenating the encoded block data items whose calculated encoding errors satisfy the allowance condition,
wherein each of the block data items whose calculated encoding error fails to satisfy the allowance condition is segmented into a block data item having a smaller data amount than the segmented block data.

36. A texture decoding method comprising:
acquiring encoded data of a texture set provided under a plurality of different conditions;
acquiring a plurality of texture coordinates for designating pixel positions and a conditional parameter for designating a condition in the conditions;
loading, from the encoded data, a block data item corresponding to the texture coordinates and the conditional parameter;
decoding the loaded block data item; and
calculating a plurality of pixel data items based on the decoded data items.

37. A texture decoding method comprising:
acquiring encoded data of a texture set provided under a plurality of different conditions;
converting a size of a block contained in the encoded data into a fixed block size;
acquiring a plurality of texture coordinates for designating pixel positions and a conditional parameter for designating a condition in the conditions;
loading, from the converted encoded data, a block data item corresponding to the texture coordinates and the conditional parameter;
decoding the loaded block data item; and
calculating a plurality of pixel data items based on the decoded block data item.

38. A texture encoding program stored in a computer readable medium, comprising:
means for instructing a computer to acquire texture data of a texture set provided under a plurality of different conditions;
means for instructing the computer to segment the texture data into a plurality of block data items each of which contains a plurality of pixel data items whose values corresponding to the conditions fall within a first range and whose pixel positions fall within a second range in the texture set;
means for instructing the computer to encode each of the block data items to produce a plurality of encoded block data items; and
means for instructing the computer to concatenate the encoded block data items to generate an encoded data item of the texture set.

39. A texture encoding program stored in a computer readable medium, comprising:
means for instructing a computer to acquire texture data of a texture set provided under a plurality of different conditions;
means for instructing the computer to segment the texture data into a plurality of block data items each of which contains a plurality of pixel data items whose values corresponding to the conditions fall within a first range and whose pixel positions fall within a second range in the texture set;
means for instructing the computer to encode each of the block data items to produce a plurality of encoded block data items;
means for instructing the computer to calculate an encoding error of each of the encoded block data items;
means for instructing the computer to compare, for each of the encoded block data items, the calculated encoding error with an allowance condition indicating an encoding error within a range; and
means for instructing the computer to concatenate the encoded block data items whose calculated encoding errors satisfy the allowance condition,
wherein each of the block data items whose calculated encoding error fails to satisfy the allowance condition is segmented into a block data item having a smaller data amount than the segmented block data.

40. A texture decoding program stored in a computer readable medium, comprising:
means for instructing a computer to acquire encoded data of a texture set provided under a plurality of different conditions;
means for instructing the computer to acquire a plurality of texture coordinates for designating pixel positions and a conditional parameter for designating a condition in the conditions;
means for instructing the computer to load, from the encoded data, a block data item corresponding to the texture coordinates and the conditional parameter;
means for instructing the computer to decode the loaded block data item; and
means for instructing the computer to calculate a plurality of pixel data items based on the decoded data item.

41. A texture decoding program stored in a computer readable medium, comprising:
means for instructing a computer to acquire encoded data of a texture set provided under a plurality of different conditions;
means for instructing the computer to convert a size of a block contained in the encoded data into a fixed block size;
means for instructing the computer to acquire a plurality of texture coordinates for designating pixel positions and a conditional parameter for designating a condition in the conditions;
means for instructing the computer to load, from the converted encoded data, a block data item corresponding to the texture coordinates and the conditional parameter;
means for instructing the computer to decode the loaded block data item; and
means for instructing the computer to calculate a plurality of pixel data items based on the decoded block data item.
